(19) United States
(12) Patent Application Publication
(10) Pub. No.: US 2009/0309371 A1
(43) Pub. Date: Dec. 17, 2009

(54) System and Method of Power Production

(76) Inventor: Darin Ballard, Savoy, TX (US)

Correspondence Address: JAY M. SCHLOFF, 6960 Orchard Lake Road, Suite 315, West Bloomfield, MI, 48322, US

(21) Appl. No.: 12/436,591

(22) Filed: May 6, 2009

Related U.S. Application Data
(60) Provisional application No. 61/061,146, filed on Jun. 13, 2008.

(51) Int. Cl. H02K 7/18; H02K 53/00

(52) U.S. Cl. 290/1 R; 415/916

(57) ABSTRACT

A system and method for efficient power production through the use of compressed air. The system and method provide for a self-contained system and method for providing power such that power may be supplied at remote locations without the requirement of coupling to an existing power supply. The power producing system generally comprises an air motor, an electric generator, an air compressor, and a compressed air tank which are operatively coupled to produce power which may be supplied to one or more electrical devices.

### CROSS REFERENCE TO RELATED APPLICATIONS

The present application claims priority from U.S. Provisional Patent Applications Ser. No. 61/061,146 filed Jun. 13, 2008, which is incorporated herein by reference.

### FIELD OF THE INVENTION

The present invention generally relates to the production of power. More particularly, the present invention relates to a system and method of efficient power production through the use of compressed air.

### BACKGROUND

The need for power to operate machinery, vehicles, electronics and the like is immediately apparent in today's mechanized and computerized world. Ongoing concerns with the supply of power include the amount of power that can be supplied and the cost of such power. For instance, energy obtained during peak times may be much more expensive than energy obtained during off-peak times. The cost of energy also fluctuates based on the cost of the fossil fuels used to create such energy.

Recent increases in the cost and demand for fossil fuels have made concern relating to the supply of power much more urgent. Alternative forms of energy are becoming more and more popular with various types of alternative energy sources being used on a daily basis. Types of alternative energy such as solar, wind, and geothermal are beginning to be utilized on a more uniform basis. Still, there exist many problems in relation to the harvesting of solar wind and geothermal energy. While the harvesting of solar and wind energy may be readily accomplished, such harvesting processes still have many inefficiencies that hinder widespread use. Geothermal energy is also limited to certain geographical regions.

In making the transition to alternative forms of energy, various types of systems have been developed to increase the efficiency of current forms of energy. An example of such a system is a hybrid vehicle system. A hybrid vehicle system allows automobiles to be powered by a combination of gasoline and electrical energy. While hybrid vehicle systems have increased the energy efficiency of vehicles, there is still much room for improvement.

While many types of technology exist for the creation of alternative energy and increased efficiency in energy production, there remains a need for a system and method for providing increased efficiency in the production of power.

### SUMMARY OF THE INVENTION

Disclosed herein, is a power producing system comprising an air motor supplied with a stream of compressed air from a compressed air tank via an air pipeline, the stream of compressed air powering said air motor; an electric generator mechanically coupled to the air motor via one or more drive shafts, the air motor providing rotational energy to the electric generator to produce electrical current; and an air compressor in gaseous communication with the compressed air tank, the air compressor supplying the compressed air tank with compressed air. The stream of compressed air may be in the range of 100 to 200 psi. The compressed air tank may comprise a one way valve for receiving a supply of compressed air from an outside source of compressed air. The power producing system may further comprise one or more electrical outlets for providing electrical current produced from the electric generator to one or more electrical devices.

The air compressor may be powered by an electric motor. The electric motor may be powered by the electric generator during operation of the power producing system. The electric motor may be in mechanical communication with the air compressor via a belt and pulley system. The electric motor may be electrical communication with an outside power source and/or a rechargeable battery to provide power to the electric motor during start-up of the power producing system. The rechargeable battery may be in electrical communication with the electric generator such that the rechargeable battery is charged during operation of the power producing system. The power producing system may further comprise an air pressure switch coupled to the air pipeline, the air pressure switch controlling operation of the electric motor to regulate the pressure of the compressed air within the compressed air tank.

The power producing system may further comprise a gear reducer. The gear reducer receives rotational energy from the air motor at a first operation speed and provides rotational energy at a second operation speed to the electric generator, the second operation speed being greater than the first operation speed.

The power producing system may further comprise an air flow valve coupled to the air pipeline, the air flow valve controlling the flow of compressed air through the air pipeline. The power producing system may further comprising an air pressure regulator coupled to the air pipeline, the air pressure regulator controlling the pressure of the compressed air within the air pipeline.

Further disclosed herein is a method for producing power comprising supplying a stream of compressed air from a compressed air tank to an air motor; providing rotational energy from the air motor to an electric generator to produce an electrical current; supplying the electrical current to one or more electrical devices; and maintaining the pressure of the compressed air within the compressed air tank with an air compressor, the air compressor being powered by an electric motor powered by the electric generator. The stream of compressed air may be in the range of 100 to 200 psi.

The method may further comprise powering the electric motor with an outside power source or a battery during start-up. The battery may be a rechargeable battery wherein the rechargeable battery is in electrical communication with the electric generator such that said rechargeable battery is charged by the electric generator. The method may further comprise supplying the compressed air tank with a supply of compressed air from an outside source prior to start-up.

### BRIEF DESCRIPTION OF THE DRAWINGS

FIG. 1 is a depiction of a perspective view of a system for providing power in accordance with the present invention.

FIG. 2 is another depiction of a perspective view of a system for providing power in accordance with the present invention.

### DETAILED DESCRIPTION OF THE PREFERRED EMBODIMENTS OF THE INVENTION

In accordance with the present invention there is provided a system and method for efficient power production through the use of compressed air. The system and method for producing power provide for efficient operation yielding a cost-effective rate of power production. The system and method also provide for a self-contained system and method for providing power such that power may be supplied at remote locations without the requirement of coupling to an existing power supply.

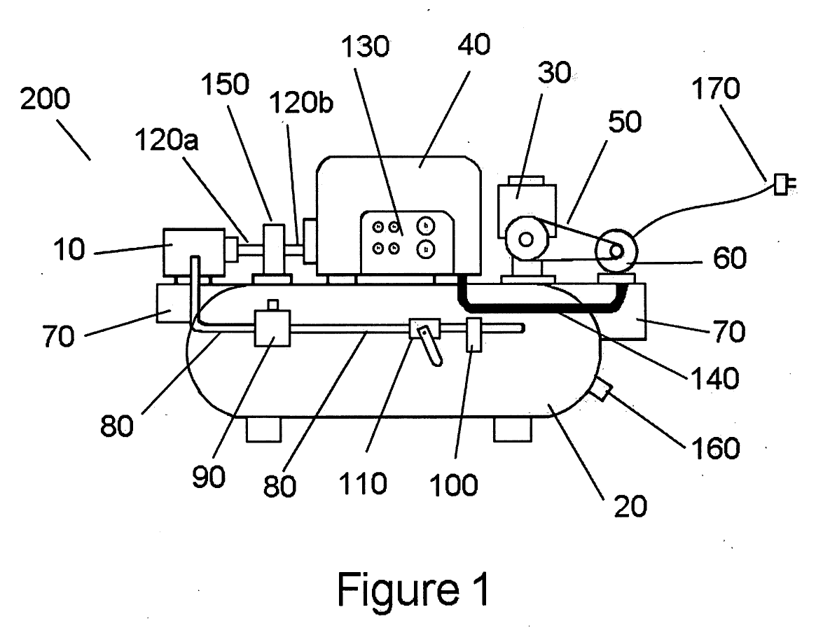

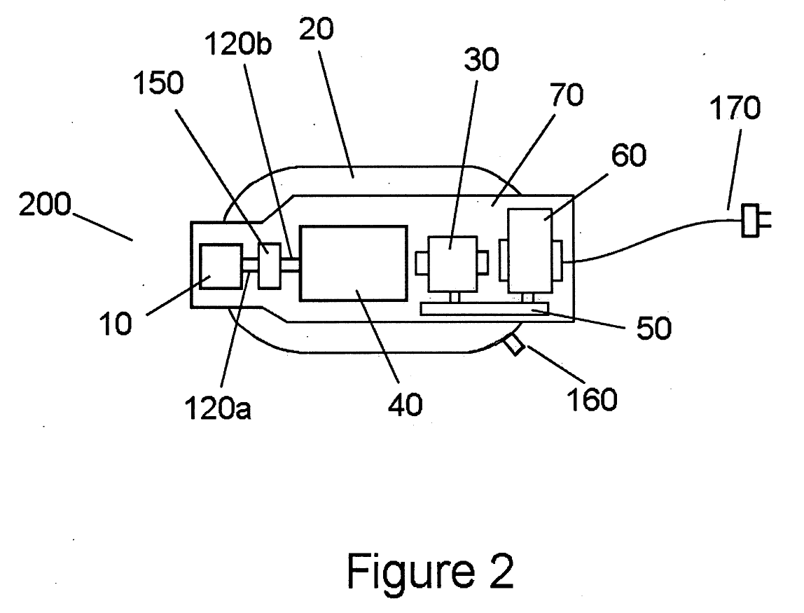

The power producing system 200 generally comprises an air motor 10, an electric generator 40, an air compressor 30, and a at least one compressed air tank 20 as depicted in FIGS. 1 and 2. The air motor 10, electric generator 40, air compressor 30, and air tank 20 are operatively coupled to produce power which may be supplied to one or more electrical devices. The system components may be attached to a rigid plate 70 which maintains and supports the system as a single unit.

The air motor 10 included in the power producing system is powered by compressed air. The air motor may be any type motor operable upon receiving a supply of compressed air. Operation of the air motor is initiated by receiving a supply of pressurized air from the compressed air tank. The air motor may be a four horsepower motor operable upon receiving a force of 80 pounds per square inch from compressed air. Such a motor may operate at 2200 revolutions per minute (rpm) consuming approximately 25 cubic feet per minute (cfm) of compressed air and producing 32.8 foot pounds of stall torque at 600 rpm and 24.2 foot pounds of running torque at 2200 rpm. The air motor accordingly provides power to operate the electric generator.

The electric generator 40 may be any type electric generator known in the art able to produce an electrical current upon being provided rotational energy from the air motor 10. As such, the electric generator 40 is in mechanical communication with the air motor 10. The electric generator may produce 8000 watts of electric power and one of 120 volts and 240 volts of alternating current. The electric generator 40 may operate at 28.6 foot pounds of stall torque and 23.3 foot pounds of running torque to achieve 3600 rpm. The electric generator may produce 80 amps of electricity on the three phase (240 volt) side and 30 amps of electricity on the single phase (110 volt) side. To operate the electric generator, rotational energy is transferred from the air motor to the electric generator via one or more drive shafts 120a, 120b. The drive shafts 120a, 120b may be formed from cylindrical rods made from steel or other rigid materials. When using two or more drive shafts to transfer rotational energy from the air motor 10 to the electric generator 40, a gear reducer 150 may be used to increase the rpm provided from the air motor 10. For instance, an operation speed of 2200 rpm from the air motor 10 may be increased by the gear reducer 150 to an operation speed of 3600 rpm which is provided to the electric generator 40.

The compressed air tank 20 is operable to supply compressed air to the air motor 10. The compressed air tank 20 may be any type pressure containment vessel known in the art for the storage of pressurized gas. The compressed air tank 20 has a design necessary to contain pressurized air within the pressure ranges disclosed herein. The compressed air tank 20 may be formed from metal, plastic, composite, and any combination thereof. For high pressure operation, the compressed air tank 20 may have a wrap around the exterior of the tank, such as carbon fiber wrap, to prevent damage to the tank from high pressure operation. The compressed air tank 20 may receive a supply of pressurized air from an air compressor included in the power producing system. Alternatively, the compressed air tank 20 may receive a supply of compressed air from an outside source via a one way valve 160 in one way communication with the interior of the compressed air tank. The compressed air tank 20 may be supplied with compressed air from an outside source when preparing the power producing system for start-up.

The air compressor 30 operates to provide a supply of compressed air to the compressed air tank during operation of the power producing system. The air compressor 30 may be any type of air compressor known in the art. Preferably, the air compressor 30 is capable of producing air at a range of 110 psi to 190 psi at a volume of 35 cubic feet per minute. To provide compressed air to the compressed air tank, the air compressor 30 is in fluid communication with the interior of the compressed air tank 20. The air compressor 30 may be powered by an electric motor 60 which is coupled to the air compressor via a belt and pulley system 50. Alternatively, the electric motor 60 and air compressor 30 may be operatively coupled by any facilitative mechanism know in the art. The electric motor 60 may be a 5 horsepower 3-phase motor that draws 14 amps or 1540 watts to operate. During operation of the power producing system 200, the electric motor 60 may be powered by the electric generator 40 via a hard wired electrical connection 140. During start-up the electric motor may be powered from an outside source via and electric power cord 170. Alternatively, during start-up the electric motor may be powered from an onboard battery or rechargeable battery hard wired to the electric motor. The rechargeable battery may be in electrical communication with the electric generator such that the rechargeable battery may be recharged during operation of the power producing system.

During operation of the power producing system 200, air is supplied from the compressed air tank to the air motor via an air pipeline 80. The air pipeline may be formed from one or more pipes operable at pressures within the scope of the invention. The air pipeline may include an air flow valve 110 used to turn on or turn off the flow of air through the air pipeline. The air flow valve 110 may be operated manually or automatically. The air pipeline 80 may additionally include an air pressure switch 100 which turns the air compressor 30 on or off based on the flow of air through the air pipeline. The air pressure switch 100 may regulate operation of the electric motor 60 such that a level of the air pressure inside the compressed air tank is adjusted or maintained. The air pressure switch 100 may draw power from the electric generator 40 to permit operation of the air pressure switch. The air pipeline may also include an air pressure regulator 90. The air pressure regulator 90 controls the pressure of the compressed air within the air pipeline 80 such that the compressed air is at a pressure that will not cause damage to the air motor and also ensures the air pressure is of a sufficient pressure to engage the air motor.

The power producing system 200 may further comprise one or more electrical outlets 130 for receiving electrical connectors or plugs of a device or appliance to which the system may provide power. The system may alternatively comprise a plurality of such outlets for accommodating a plurality of devices or appliances. The one or more electrical outlets 130 may be integrated into or mounted on the electric generator 40.

Prior to operation of the power producing system, the air tank 20 is preferably filled with compressed air. To fill the air tank 20, the air compressor 30 may be powered from an outside power source via an electric power cord 170 to fill the air tank 20 or compressed air may be provided to the air tank 20 via a the one-way valve 160 from an outside source. Alternatively, the air compressor 30 may be powered from a battery or a rechargeable battery onboard the system. The rechargeable battery may be in communication with the electric generator 40. Once the air tank has been filled with air to the necessary operating pressure, the power producing system 200 is ready for operation.

To begin operation of the power producing system, compressed air is released from the air tank 20 and supplied to the air motor 10 via the air pipeline 80. The compressed air may be released from the air tank 20 via actuation of an air flow valve 110. The air flow valve 110 may be located on the air pipe line 80 which provides air from the air tank 20 to the air motor 10. Upon actuation of the air flow valve 110, the compressed air flows through the air line pipe 80 until reaching an air pressure switch 100. The air pressure switch 100 operates to regulate the air pressure in the air tank 20. The air pressure switch 100 regulates the air pressure in the air tank 20 by turning the electric motor 60 on and off to operate the air compressor 30 such that a pressure range may be maintained within the air tank 20. The operating pressure of the air tank 20 is preferably within the range of 100 to 200 psi for optimal operation of the power producing system 200.

Upon reaching the air pressure switch 100 the compressed air continues to flow through the air pipeline 80 until reaching the air pressure regulator 90. The air pressure regulator 90 regulates the pressure of the compressed air such that the compressed air is at a pressure that will not cause damage to the air motor 10 and ensures the air pressure is of a sufficient pressure to engage the air motor 10. Upon passing the air pressure regulator 90, the compressed air continues to flow through the air pipeline 80 to the air motor 10 thus setting the air motor in motion. The air motor 10 may require 25 cubic feet of compressed air per minute for operation.

The air motor is connected to the drive shaft 120a which provides a rotational movement to the gear reducer 150. The gear reducer 150 then provides a rotational movement to the electric generator 40 via a second drive shaft 120b. Once the rotational movement is provided by the drive shaft 120b to the electric generator, the electric generator begins producing electrical current which may be available for use via one or more electrical outlets 130 and provided to the electric motor 60 to power the air compressor 30 via an electrical conduit 140.

Upon electrical current being received by the electric motor 60, the electric motor begins powering the air compressor 30 which provides compressed air to the air tank 20. The electric motor 60 may be connected to the air compressor 30 via a belt and pulley system 50. The air compressor may be operated which produces up to 35 cubic feet of compressed air per minute. The 35 cubic feet of air produced by the air compressor is stored within the air tank to provide a reserve storage of compressed air to provide the necessary 25 cubic feet of compressed air per minute to the air motor 10. At this point the air compressor 30 is producing more air than required by the air motor 10 which activates the operation of the air pressure switch 100. The air pressure switch 100 then regulates the flow of compressed air into the air tank 10 by turning the electrical power to the electric motor 60 on and off to provide the necessary pressure in the air tank 10. The pressure settings of the air pressure switch 100 may be 100 psi for the low air pressure setting and 190 psi for the high air pressure setting. The low pressure setting and the high pressure setting will be the minimum and maximum air pressure within the air tank 20.

In a preferred embodiment of the present invention, the air tank may be maintained in the range of 100 psi to 200 psi. Preferably the air tank is maintained at 190 psi. Compressed air from the air tank may be supplied to the air motor at a rate of 25 cubic feet per minute at a pressure ranging from 100 to 190 psi. Upon receipt of the compressed air by the air motor, the air motor provides rotational movement to the electric generator via one or more drive shafts which causes the electric generator to produce 8000 watts of electricity. Of the 8000 watts, 1540 watts may be supplied to the electric motor to operate the air compressor. The remaining 6460 watts of electricity may be provided to one or more electrical outlets and available for use to power one or more electrical devices.

While there have been described what are believed to be the preferred embodiments of the present invention, those skilled in the art will recognize that other and further changes and modifications may be made thereto without departing from the spirit of the invention, and it is intended to claim all such changes and modifications as fall within the true scope of the invention.

1. A power producing system comprising:
an air motor supplied with a stream of compressed air from a compressed air tank via an air pipeline, said stream of compressed air powering said air motor;
an electric generator mechanically coupled to said air motor via one or more drive shafts, said air motor providing rotational energy to said electric generator to produce electrical current; and
an air compressor in gaseous communication with said compressed air tank, said air compressor supplying said compressed air tank with compressed air.

2. The power producing system according to claim 1, wherein said air compressor is powered by an electric motor, said electric motor being powered by said electric generator during operation of said power producing system.

3. The power producing system according to claim 2, wherein said electric motor is electrical communication with an outside power source, said outside power source providing power to said electric motor during start-up of said power producing system.

4. The power producing system according to claim 2, wherein said electric motor is electrical communication with a rechargeable battery, said rechargeable battery providing power to said electric motor during start-up of said power producing system.

5. The power producing system according to claim 4, wherein said rechargeable battery is in electrical communication with said electric generator such that the rechargeable battery is charged during operation of said power producing system.

6. The power producing system according to claim 2, wherein said electric motor is in mechanical communication with said air compressor via a belt and pulley system.

7. The power producing system according to claim 2 further comprising an air pressure switch coupled to said air pipeline, said air pressure switch controlling operation of said electric motor to regulate the pressure of the compressed air within said compressed air tank.

8. The power producing system according to claim 1 further comprising a gear reducer, said gear reducer receiving rotational energy from said air motor at a first operation speed and providing rotational energy at a second operation speed to said electric generator, said second operation speed being greater than said first operation speed.

9. The power producing system according to claim 1 further comprising an air flow valve coupled to said air pipeline, said air flow valve controlling the flow of compressed air through said air pipeline.

10. The power producing system according to claim 1 further comprising an air pressure regulator coupled to said air pipeline, said air pressure regulator controlling the pressure of the compressed air within the air pipeline.

11. The power producing system according to claim 1, wherein said compressed air tank comprises a one way valve for receiving a supply of compressed air from an outside source of compressed air.

12. The power producing system according to claim 1 further comprising one or more electrical outlets for providing electrical current produced from said electric generator to one or more electrical devices.

13. The power producing system according to claim 1, wherein said stream of compressed air is in the range of 100 to 200 psi.

14. A method for producing power comprising:
supplying a stream of compressed air from a compressed air tank to an air motor;
providing rotational energy from said air motor to an electric generator to produce an electrical current;
supplying said electrical current to one or more electrical devices; and
maintaining the pressure of the compressed air within said compressed air tank with an air compressor, said air compressor being powered by an electric motor powered by said electric generator.

15. The method for producing power according to claim 14 further comprising:
powering said electric motor with an outside power source during start-up.

16. The method for producing power according to claim 14 further comprising:
powering said electric motor with a battery during start-up.

17. The method for producing power according to claim 14 further comprising:
powering said electric motor with a rechargeable battery during start-up, said rechargeable battery being in electrical communication with said electric generator such that said rechargeable battery is charged by said electric generator.

18. The method for producing power according to claim 14 further comprising the step:
supplying said compressed air tank with a supply of compressed air from an outside source prior to start-up.

19. The method according to claim 14, wherein said stream of compressed air is in the range of 100 to 200 psi.
